(19) United States
(12) Patent Application Publication
(10) Pub. No.: US 2008/0059477 A1
(43) Pub. Date: Mar. 6, 2008

(54) Method and system for tracking service orders

(75) Inventor: Brenda Dietrich, Wellsville, KS (US)

Correspondence Address: PATTON BOGGS, L.L.P., 2001 ROSS AVENUE, SUITE 3000, DALLAS, TX, 75201, US

(73) Assignee: Embarq Holdings Company LLC, Overland Park, KS (US)

(21) Appl. No.: 11/512,782

(22) Filed: Aug. 30, 2006

(51) Int. Cl. G06F 17/30

(52) U.S. Cl. 707/10

(57) ABSTRACT

A method and system for tracking service orders of service activities each having a service activity date from a sender to a recipient with an email application operating via a communications network. Emails are generated by the sender that have a first portion including a first data from the service order and a second portion including a second data from the service order. An inbox is created at the recipient for the receipt of the email. Also, at least one subfolder is created at the recipient, the subfolder is identified by a conversion date associated with a particular set of first data, and the at least one subfolder in communication with the inbox. The email is sent to the recipient. The first and second data of the email is searched, and the email is moved to a corresponding one of the at least one subfolders identified by the first data.

### RELATED APPLICATIONS

Not applicable

### FEDERALLY SPONSORED RESEARCH OR DEVELOPMENT

Not applicable

### MICROFICHE APPENDIX

Not applicable

### BACKGROUND OF THE INVENTION

1. Field of the Invention

The invention relates generally to computer networks, and more particularly, to systems and methods for tracking service orders.

2. Description of the Prior Art

Large service companies, like telecommunications companies, oftentimes perform engineering related activities that effect large populations of customers, such as cities. These activities are typically initiated through service orders for each customer within the population, which creates an enormous volume of customer service orders for the company to track. For example, there may be over 400 customer service orders generated in a single day for a large telecommunications company undertaking a particular engineering activity, such as converting telephone service from a circuit to packet based system.

The processing of these service orders is a crucial function to the company to ensure that there are no missed service order issues during the activity that would result in a particular customer not receiving the service from the company. Processing telecommunication service orders, from the time they are requested by customers, to the time they are implemented in the company's network, is an intricate and complicated process involving numerous activities that must be completed by various groups within the company. Monitoring this process can be a time consuming and tedious task that is susceptible to human error, such as dropped or missed service orders. Generally, many of these activities depend on one another in that they cannot begin until others are completed. This interdependency between activities and the various telecommunication organizations, make it difficult to monitor these service orders in an economical and efficient manner.

Conventionally, processing telecommunication service orders is largely a manual process where service and work orders are manually transferred from one organization to the next as tasks are completed. The transfer of these service orders is generally accomplished via internal mail, facsimile, electronic messages and the like. Typically, such organizations receive little or no advance notice about orders before they arrive, and therefore have little or no time to plan and prepare for the activities involved. Further, these large-scale activities generally require that the activities be done in stages, so it is important for the central office to be able to efficiently process those service orders relating to each particular days activities, which is difficult and time-consuming to do with the present systems noted.

Therefore, what is needed is an efficient and economical method and system for processing service orders and for managing and tracking the associated processing of the service orders for these activities.

### SUMMARY OF THE INVENTION

The above-described problems are solved and a technical advance is achieved by the present system and method for tracking service orders (“Service Order Tracking System”). The present Service Order Tracking System includes an email environment operated on a computer network.

Preferably, the service order tracking system tracks service orders of service activities each having a service activity date from a sender to a recipient with an email application operating via a communications network, the system including: a means for generating at the sender an email having a first portion including a first data from the service order and a second portion including a second data from the service order; a means for creating an inbox at the recipient for the receipt of the email; a means for creating at least one subfolder at the recipient identified by a conversion date associated with a particular set of first data, the at least one subfolder in communication with the inbox; a means for sending the email to the recipient over the communications network; a means for receiving the email at the inbox; a means for searching, responsive to the receipt of the email in the inbox, the first data and the second data of the email; and a means for moving the email to a corresponding one of the at least one subfolders identified by the first data of the service order. Preferably, the first data of the service order are alphanumerical characters corresponding to the service activity date. Preferably, the second data of the service order are alphanumerical characters corresponding to a descriptor of the service activity. Preferably, the means for receiving the email at the inbox further comprises: a means for receiving the email from a selected sender. Preferably, the first portion comprises a subject line of the email. Preferably, the second portion comprises a body of the email. Preferably, the particular set of first data comprises: a select set of service activity dates associated with the conversion date.

### BRIEF DESCRIPTION OF THE DRAWINGS

FIG. 1 illustrates a block diagram of a standard email system for sending and receiving email over a network according to an embodiment of the present invention;

FIG. 2 illustrates an exemplary table containing schedule data for the conversion of a wire center from a circuit system to a packet system according to an embodiment of the present invention;

FIG. 3 illustrates an exemplary screen shot of a directory of subfolders identified by the stage of the conversion for storing and tracking of service orders according to an embodiment of the present invention;

FIG. 4 illustrates an exemplary screen shot of a function for organizing service orders according to an embodiment of the present invention;

FIG. 5 illustrates an exemplary screen shot of a rules function for tracking service orders according to an embodiment of the present invention;

FIG. 6 illustrates another exemplary screen shot of a rules function for tracking service orders according to an embodiment of the present invention;

FIG. 7 illustrates an exemplary screen shot of a selection of rules for tracking service orders according to an embodiment of the present invention;

FIG. 8 illustrates an exemplary screen shot of a selection of conditions related to the rules for tracking service orders according to an embodiment of the present invention;

FIG. 9 illustrates another exemplary screen shot of a selection of conditions related to the rules for tracking service orders according to an embodiment of the present invention;

FIG. 10 illustrates an exemplary screen shot of a list of addresses for incoming service orders for tracking service orders according to an embodiment of the present invention;

FIG. 11 illustrates another exemplary screen shot of a selection of conditions related to the rules for tracking service orders according to an embodiment of the present invention;

FIG. 12 illustrates an exemplary screen shot of a search field in the subject of a service order for tracking service orders according to an embodiment of the present invention;

FIG. 13 illustrates another exemplary screen shot of a selection of conditions related to the rules for tracking service orders according to an embodiment of the present invention;

FIG. 14 illustrates an exemplary screen shot of a search field in the body of a service order for tracking service orders according to an embodiment of the present invention;

FIG. 15 illustrates another exemplary screen shot of a search field in the body of a service order for tracking service orders according to an embodiment of the present invention;

FIG. 16 illustrates another exemplary screen shot of a selection of conditions related to the rules for tracking service orders according to an embodiment of the present invention;

FIG. 17 illustrates an exemplary screen shot of a selection of actions for the service order for tracking service orders according to an embodiment of the present invention;

FIG. 18 illustrates another exemplary screen shot of a selection of actions for the service order depicting a list of subfolders of conversion dates for tracking service orders according to an embodiment of the present invention;

FIG. 19 illustrates another exemplary screen shot of a selection of actions for the service order for tracking service orders according to an embodiment of the present invention;

FIG. 20 illustrates an exemplary screen shot of a selection of exceptions for tracking service orders according to an embodiment of the present invention;

FIG. 21 illustrates an exemplary screen shot of a name field relating to the created rule for tracking service orders according to an embodiment of the present invention;

FIG. 22 illustrates an exemplary screen shot of a selection of created rules for prioritizing the order in which they operate for tracking service orders according to an embodiment of the present invention;

FIG. 23 illustrates another exemplary screen shot of a selection of created rules for prioritizing the order in which they operate for tracking service orders according to an embodiment of the present invention;

FIG. 24 illustrates an exemplary screen shot of a list of locations where the inbound service orders are sent for tracking service orders according to an embodiment of the present invention;

FIG. 25 illustrates another exemplary screen shot of a selection of created rules for prioritizing the order in which they operate for tracking service orders according to an embodiment of the present invention; and

FIG. 26 illustrates a flow diagram of a process for tracking service orders according to an embodiment of the present invention.

### DETAILED DESCRIPTION OF THE PREFERRED EMBODIMENT

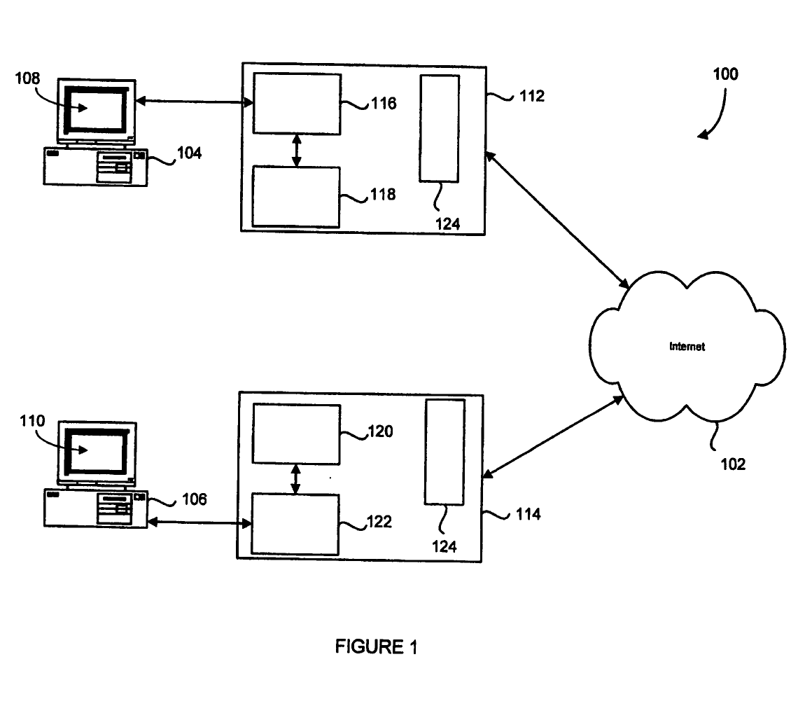

One important benefit of email in the workplace is its ability to instantaneously transmit text throughout a business. In the present service order tracking system, service or work orders can be prepared in a remote location by an individual and then can be transmitted via email to a particular department of a central office for processing. Like reference numerals are used to indicate like parts throughout the drawings. FIG. 1 is a block diagram of an embodiment of a standard email system for sending and receiving email over a network, such as the Internet, and is used to explain the present Service Order Tracking System 100. The standard email system follows a standard industry protocol for handling email on the Internet, referred to as SMTP. SMTP is a Transmission Control Protocol/Internet Protocol (“TCP/IP”) protocol for sending email between servers. Virtually all email systems that send email over the Internet use SMTP. Typically, an email is sent via SMTP to a POP3 (Post Office Protocol) server (“email server”) where an addressee retrieves the email. Because of SMTP and POP3, an addressee specifies both the POP3 server and SMTP server when they set up their email account using their email client application, such as Microsoft® Outlook®, Eudora®, Pegasus™, etc.

In FIG. 1 is shown two separate email servers, a local email server 112 and a central office email server 114. Typically, email servers 112 and 114 are used to handle the email service functions. For example, email servers 112 and 114 connect to the email clients 108 and 110, respectively, to send and receive email. Typically SMTP servers are for handling the outgoing mail, and POP3 or Internet Mail Access Protocol (“IMAP”) servers are for handling the incoming email. In FIG. 1 is shown a local SMTP server 116 and POP3 server 118 and a central office SMTP server 120 and POP3 server 122. In general, both the local SMTP server 116 and the POP3 server 118 operate together to make up the local email server 112. Likewise, the central office SMTP server 120 and POP3 server 122 operate together to make up the central office email server 114.

Local users access the Internet 102 through their company Internet servers or Internet service providers (collectively, “ISPs”) using a dialup or high-speed line connection and a standard browser, such as Internet Explorer® or Netscape®. ISPs typically have one or more SMTP servers. SMTP servers 116 and 120 generally interact with email clients 108 and 110, respectively, to send email from a local user to the central office or from a sender to an addressee. The ISP operates at a website address corresponding to its domain name which is addressable by local users on the Internet 102. The ISP's service functions are performed for a large number of users, subscribers or employees through one or more servers. The ISP or host SMTP server may interact with other SMTP servers over the Internet 102 when sending emails.

Typically, email accounts are set up with their ISP. For example, email client 108 is set up with the name of the ISP mail server, such as “serviceorder.telecom.com.” When a local user sends an email to the central office, the email client application 108, which resides on the local computer 104, typically communicates with their local SMTP server 116 telling the local SMTP server 116 the email address of the local user, the address of the addressee or central office, the subject of the email, and the body of the email, in addition to other information. The local SMTP server 116 breaks down the addressee's address into the addressee's user name and the domain name.

A typical communication involves the local user's SMTP server 116 inquiring at the Domain Name Server (“DNS”) for the Internet Protocol address (“IP address”) for the SMTP server for the domain, for example “telecom.com,” of the central office. The DNS returns to the local user's SMTP server 116 with the IP address of one or more SMTP servers 120 for the domain name “telecom.com” of the central office. The local user's SMTP server 116 then connects with the central office SMTP server 120 for the central office and inquires whether the IP address of the central office is at the central office SMTP server 120 for the central office. If the central office's IP address is at the central office's SMTP server 120, then the local user's SMTP server 116 transmits the email message to the central office's domain name or email server 114, which is then transmitted to the central office's POP3 server 122, which puts the message in the inbox of the central office's email client 110.

To receive the email, the central office logs into their POP3 server 122 from their email client 110 that resides on their central office computer 106 and issues a series of commands to the central office's POP3 server 122. Any number of remote computers 104 and central office computers 106 may be used in the present service order tracking system 100. The central office POP3 server 122 then opens the email text file and transmits the email to the central office computer 106. Generally, the central office POP3 server 122 acts as an interface between the central office email server 114 and their email client 110. After transmitting the email to the central office's email client 110, the email is deleted from the central office's POP3 server 122. The above relating to POP3 servers can also be employed on an IMAP server as well. An IMAP server holds or stores the email instead of deleting it so that it can be accessed later. Email servers 112 and 114 also typically employ queues for holding email that is not able to be transmitted instantly due to a problem or connection with other SMTPs over the Internet.

The email client applications 108 and 110 are generally a software application that is run on a remote computer 104 and a central office computer 106 that displays text and menus on the monitor of the remote computer 104 and the central computer 106. Some exemplary email client application 108 and 110 are Microsoft® Outlook®, Eudora®, Pegasus™, etc. The email client application 108 and 110 generally resides on the local drive or memory of the remote computer 104 and the central office computer 106. Among other email functions, the email client applications 108 and 110 generally display to a user all of the messages that are in their inbox, by displaying message headers that include the sender of the email, subject of the email, and the time and date that the email was sent. The email client applications 108 and 110 also allow the user to create new messages and send them to other users or addressees. Thus, for purposes of the service order tracking system 100, an email client applications 108 and 110 will be considered part of the remote computer 104 and central office computer 106, shown as email client applications 108 and 110 respectively.

In the service order tracking system 100, service orders are sent through the service order tracking system 100 via email messages that contain data generally in the form of text relating to engineering, technical, or service related activities for a telecommunication company. Preferably, the remote computers 104 or the central office computers 106 are instructed to send service orders via email that include certain data related to the conversion, dates of conversion, lines to be converted, and possibly other data in the body or subject line of the email.

Email client applications 108 and 110 preferably include server-based algorithms and client-based algorithms. A server-based algorithm is applied to an incoming email/service order regardless if the email client application is not running. Conversely, a client-based algorithm is applied to an incoming email/service order only when the email client application 108 and 110 is running.

In one embodiment, during a circuit to packet conversion, the tracking of service order activity becomes a crucial function to ensure that there are no service issues during the conversion process resulting from a missed service order. In this embodiment, the service orders will automatically be redirected to certain specified folders, thus individuals tracking the service orders will not be required to look at each service order to determine if it is affected by a specific conversion activity. Utilizing the present service order tracking system 100 allows an individual to focus on only those service orders that are involved on a specific date of activity as well as other aspects of the conversion process.

The service order tracking system 100 can be embodied in any type of email client application 108 and 110 that can operate on a network for communicating service orders from one location to another location. Referring to FIGS. 3-25, an embodiment of the service order tracking system 100 is shown operating on Microsoft® Outlook® email client application.

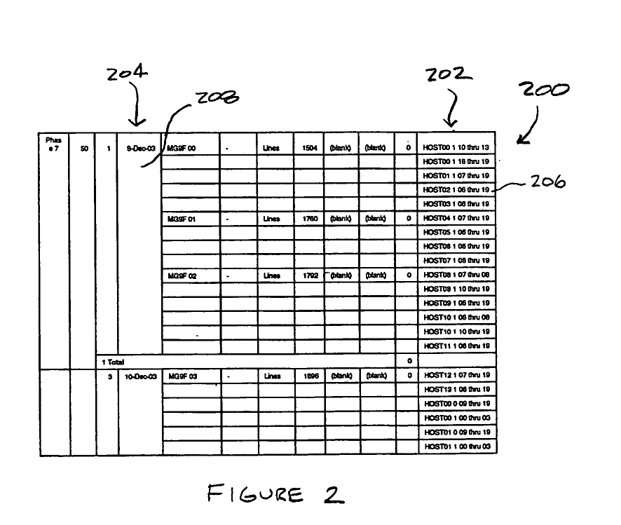

FIG. 2 illustrates an embodiment 200 of an exemplary table of data from a schedule to convert telephone lines from circuit to packet systems. Typically, the conversion table 200 includes a column 202 of service orders 206 that are scheduled to be converted on corresponding column 204 of particular dates 208. For example, particular service orders 206, such as “HOST00 1 10 thru 13” and “HOST00 1 18 thru 19,” are scheduled to be converted on 8 Dec. 2003.

FIG. 3 illustrates an embodiment 300 of an exemplary screen shot of a display produced by the present service order tracking system 100 that depicts a set 302 of subfolders 304, such as “040504.” Preferably, the subfolders 304 are created with a name indicating the date of a particular conversion activity. Typically, subfolders 304 can be created by using the file management tools provided with most software applications, such as those found in Microsoft® Outlook®.

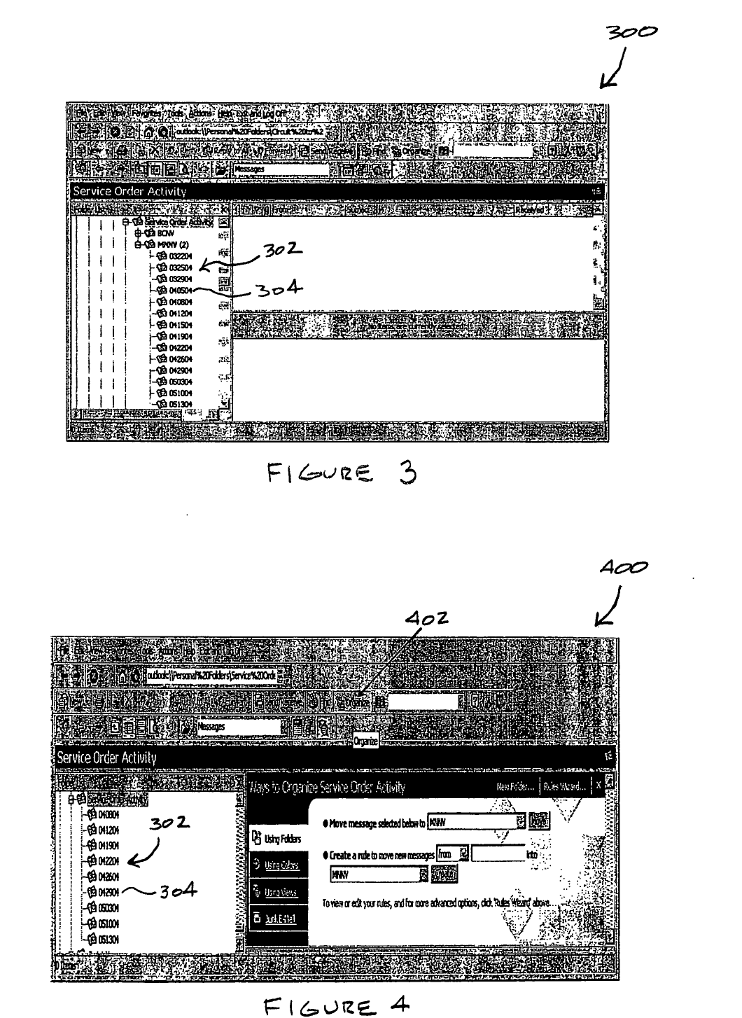

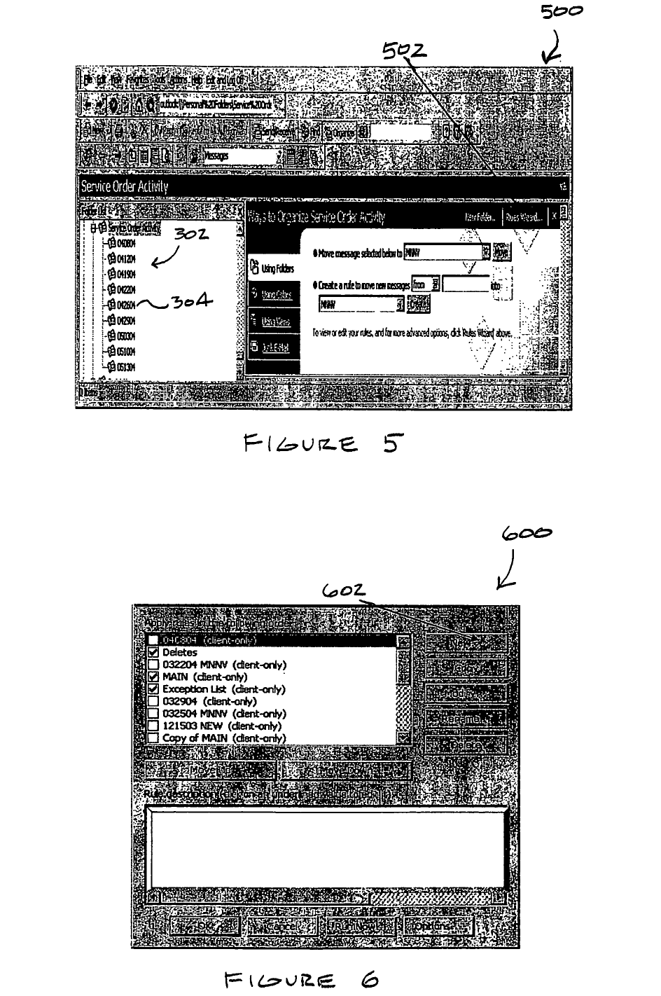

FIG. 4 illustrates an embodiment 400 of an exemplary screen shot of a display produced by the present service order tracking system 100 that depicts a function for organizing service orders 402. This function 402 helps organize the service orders 206 so that a user can more easily identify those associated with a particular date's conversion activity. FIG. 5 illustrates an embodiment 500 of an exemplary screen shot of a display produced by the present service order tracking system 100 that depicts a feature 502 for moving incoming service orders to a corresponding subfolder 304.

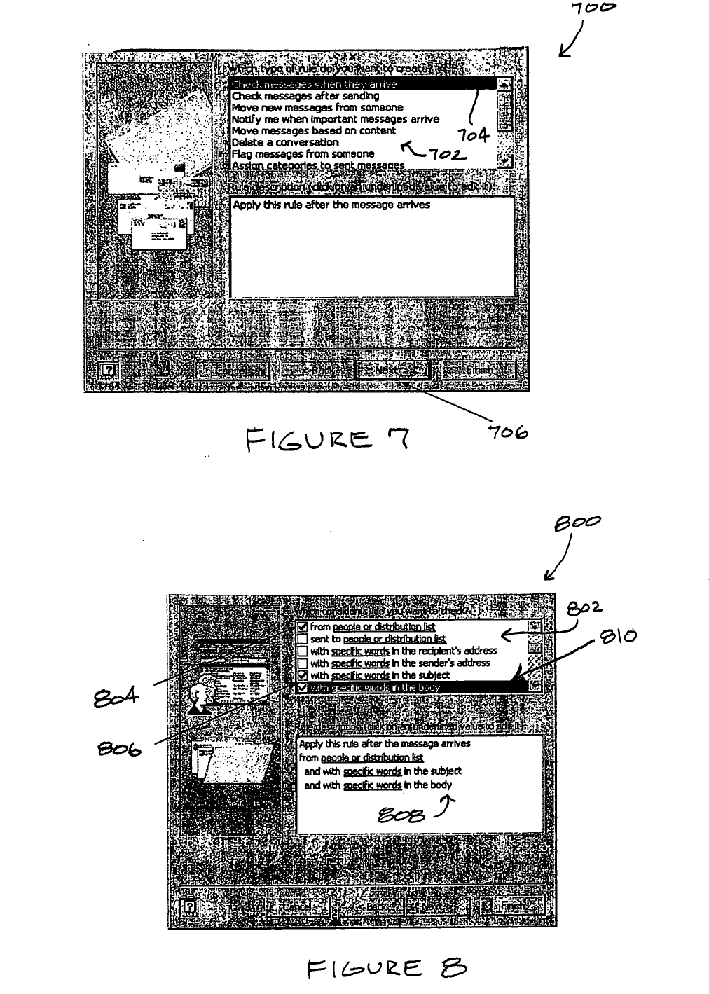

FIG. 6 illustrates an embodiment 600 of an exemplary screen shot of a display produced by the present service order tracking system 100 that depicts a button 602 for creating a service order tracking function. FIG. 7 illustrates an embodiment 700 of an exemplary screen shot of a display produced by the present service order tracking system 100 that depicts a list of rules 702 that the email client application 108 and 110 can operate on the incoming service orders 206. For example, the rule for checking arriving messages 704 is selected. After rule 704 is selected, the “next” button 706 is selected. These rules can be performed by the email client application 108 and 110 on the service orders that are already in the “Inbox” of the remote computer 104 and central office computer 106 that are accessed by a user.

FIG. 8 illustrates an embodiment 800 of an exemplary screen shot of a display produced by the present service order tracking system 100 that depicts a list of conditions 802 related to the rule for checking arriving messages 704. These conditions define the how and what operations the rule for checking arriving messages 704 performs on the service orders 206. For example, from people condition 804, with specific words in the subject condition 806, and with specific words in the body condition 810 is selected. These selections are then displayed in the rule description window 808.

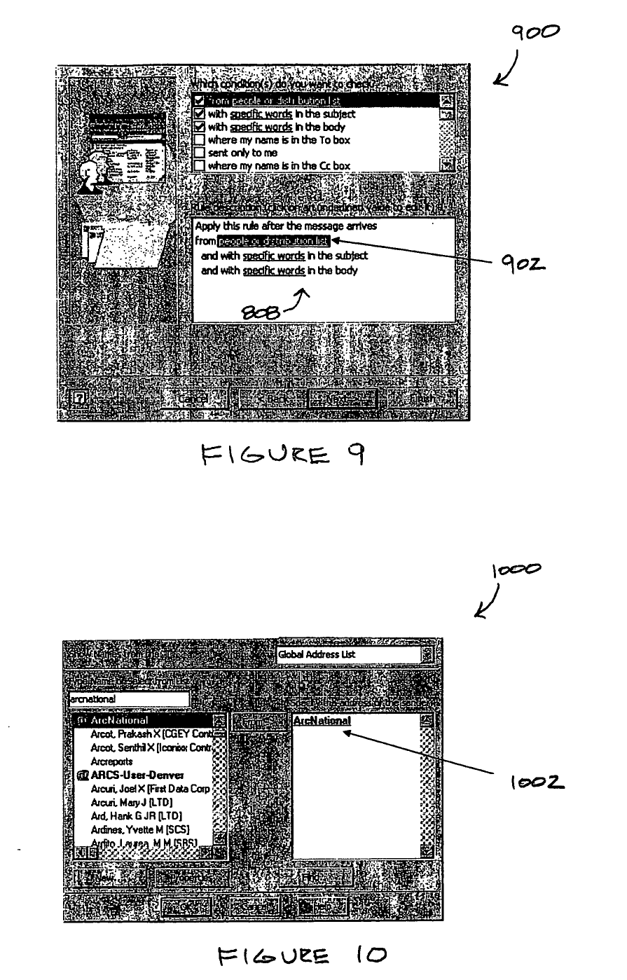

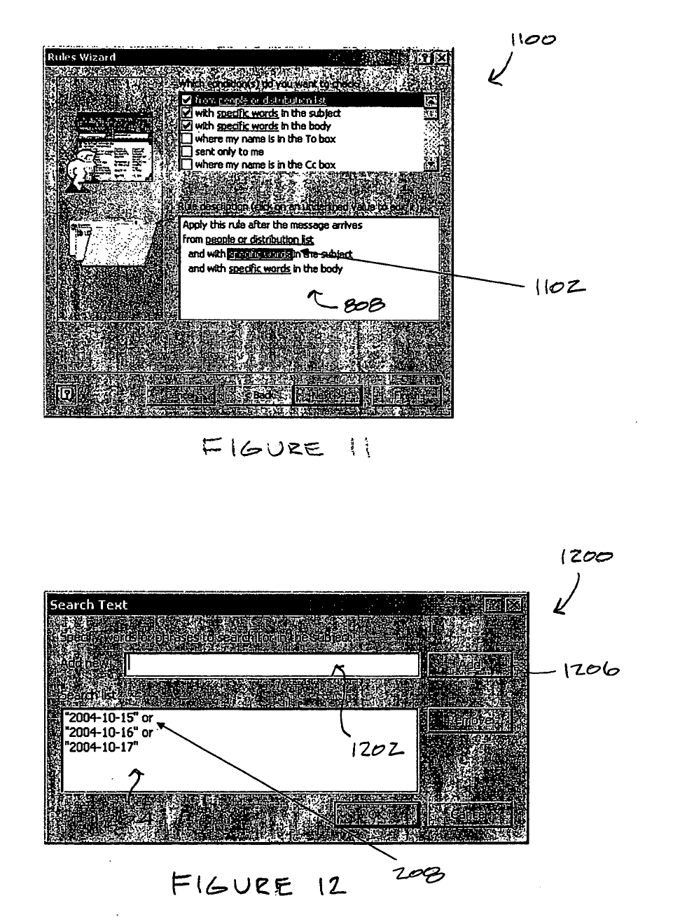

FIG. 9 illustrates an embodiment 900 of an exemplary screen shot of a display produced by the present service order tracking system 100 that depicts the selected conditions 804, 806, and 810 in the rule description window 808. By selecting 902 the displayed condition 804 in the ruled description window 808, an address list as shown by embodiment 1000 of FIG. 10 is displayed for selecting among the names of individuals or groups that generate the service orders. These individuals or groups may be remotely located or located within the central office. In FIG. 10, the group “ArcNational” is selected 1002 as being one source of service orders.

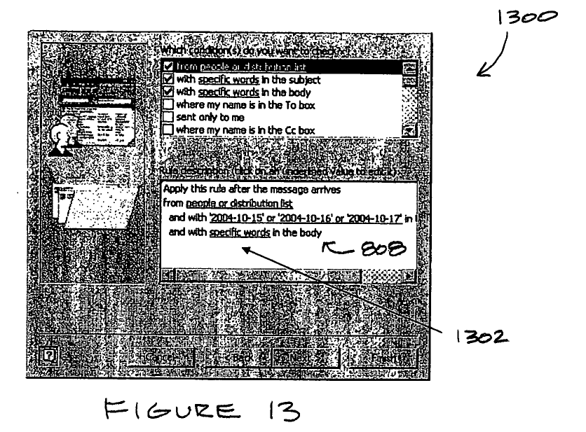

Referring to FIG. 11, an embodiment 1100 of an exemplary screen shot of a display produced by the present service order tracking system 100 that depicts the selected conditions 804, 806, and 810 in the rule description window 808 as noted above. By selecting 1102 the displayed condition 806 in the ruled description window 808, a popup window 1202 is displayed as shown by embodiment 1200 of FIG. 12 for entering the data to search for in the subject field of the service orders 206. For example, dates 208 are entered in a format into subject field 1202. An add button 1206 is selected to add the entered dates 208 of a particular conversion timeframe into the search list 1204. Additional dates corresponding to the particular conversion timeframe are similarly added, such as those shown in search list 1204.

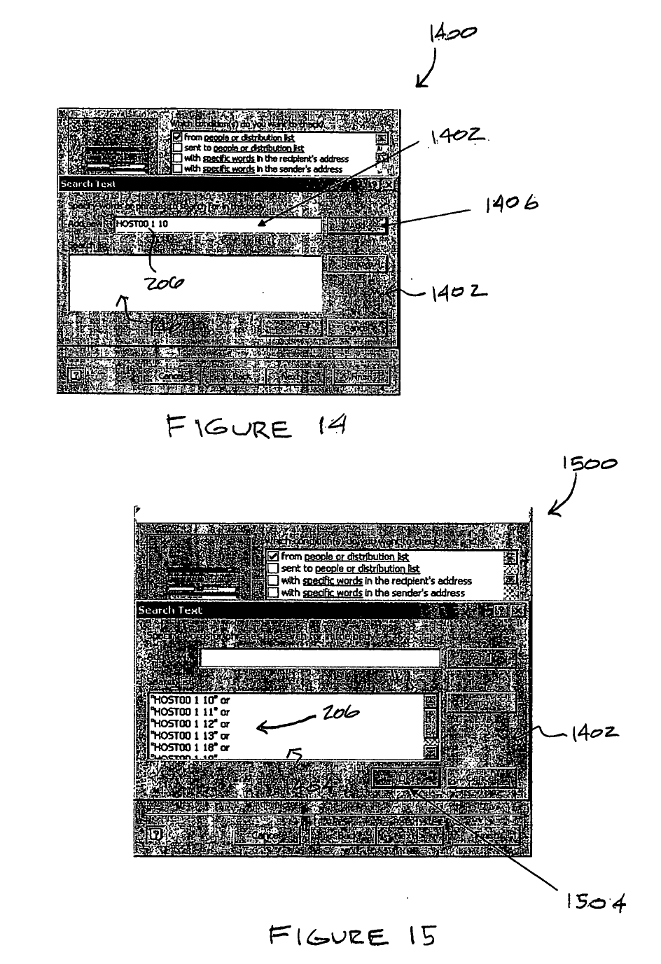

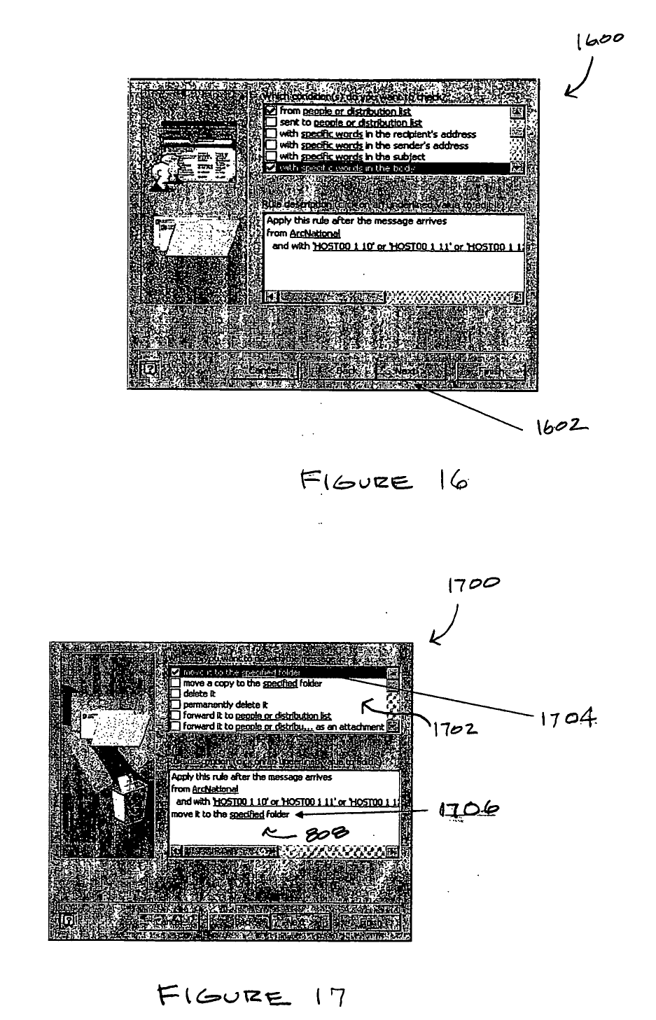

Referring to FIG. 13, an embodiment 1300 of an exemplary screen shot of a display produced by the present service order tracking system 100 that depicts the selected conditions 804, 806, and 810 in the rule description window 808 as noted above. By selecting 1302 the displayed condition 810 in the ruled description window 808, a popup window 1402 is displayed as shown by embodiment 1400 of FIG. 14 for entering the data to search for in the body of the service orders 206. For example, service orders 206 are entered in a format into body field 1402. An add button 1406 is selected to add the additional service orders 206 of a particular conversion timeframe into the search list 1404. Additional service orders 206 corresponding to the particular conversion timeframe are similarly added, such as those shown in search list 1404 of embodiment 1500 of FIG. 15 of the service order tracking system 100.

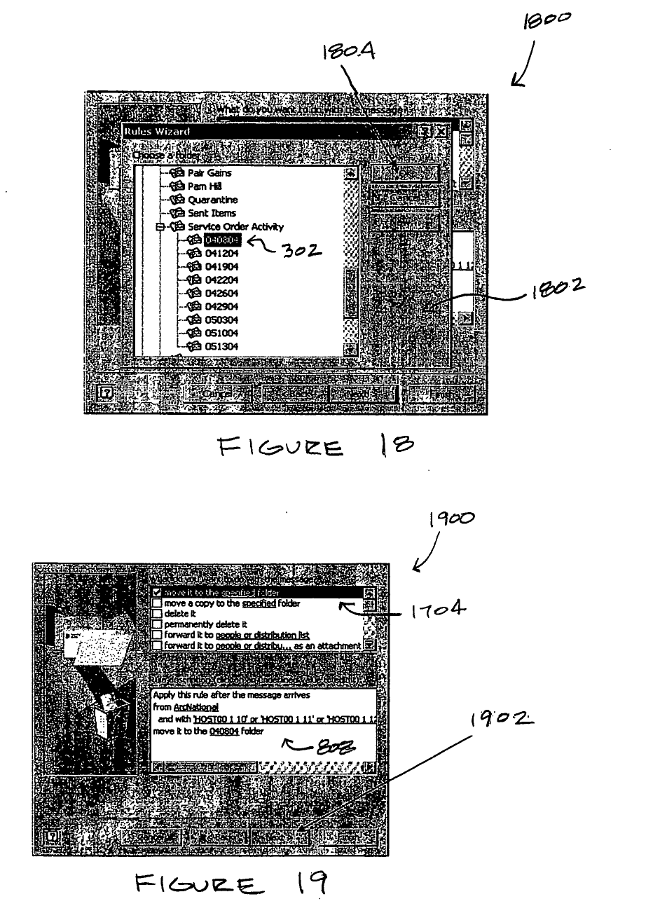

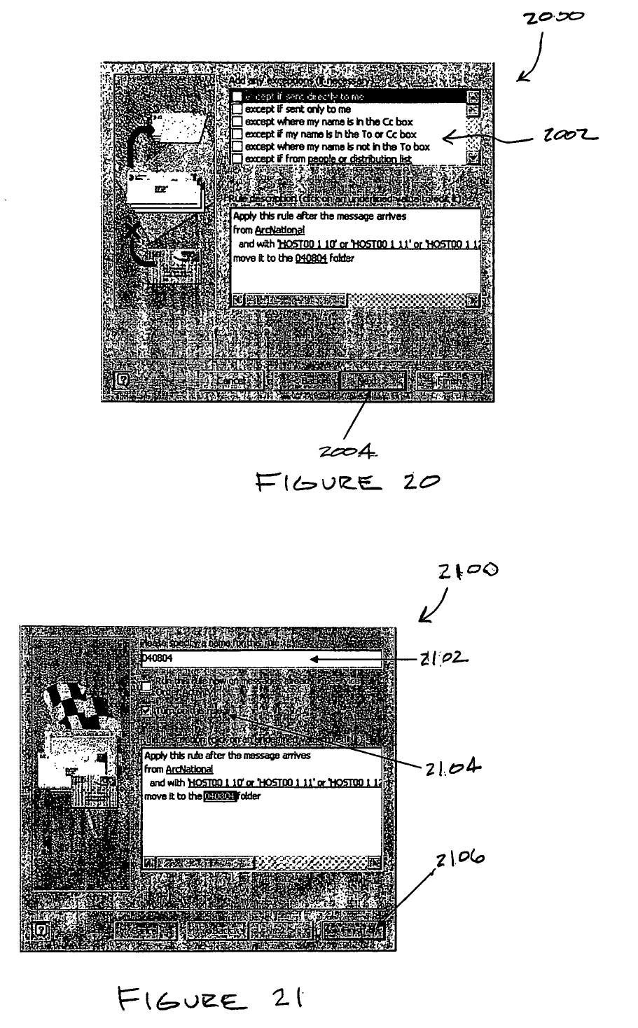

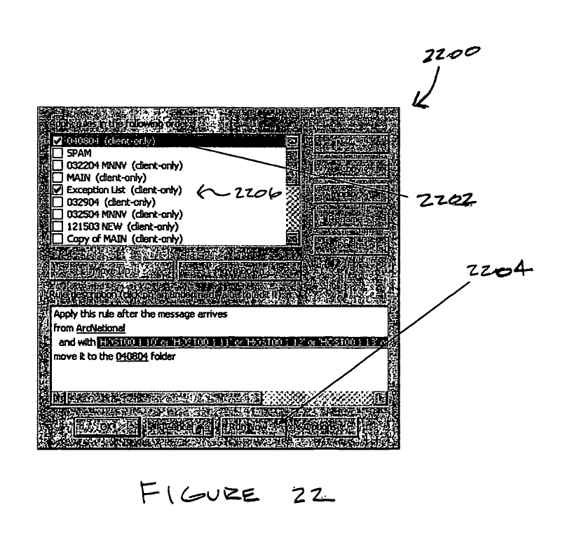

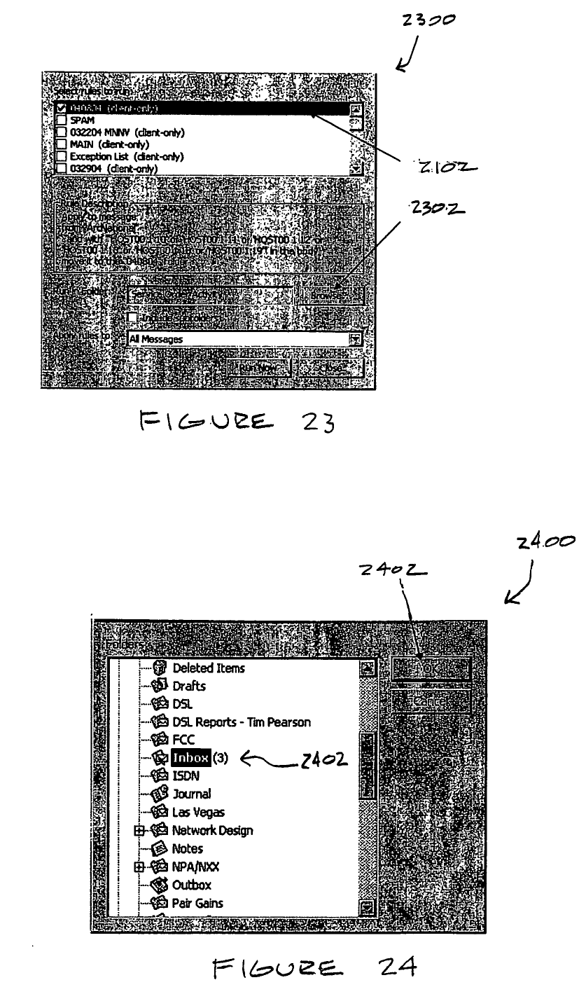

FIG. 16 illustrates an embodiment 1600 of an exemplary screen shot of a display produced by the present service order tracking system 100 that depicts the entered data to be searched within the service orders 206. Once all the data that it to be searched is entered, then a user selects the “next” button 1602, and the present service order tracking system 100 displays a selection of options related to the service orders 206 that match the data selected to be searched as described above. FIG. 17 illustrates an embodiment 1700 of an exemplary screen shot of a display produced by the present service order tracking system 100 that depicts these options found in options list 1702. Preferably, the move to a specified folder function 1704 is selected as shown in FIG. 17, which is then added to the rule description window 808. By selecting 1706 the move to a specified folder function 1704 in the ruled description window 808, a popup window 1802 is displayed as shown by embodiment 1800 of FIG. 18 for selecting a subfolder 304 to move those service orders 206 that match the data to be searched as described above. For example, the subfolder 304 “040804” is selected via “OK” button 1804 and entered in a format into rule description window 808 as shown in embodiment 1900 of FIG. 19. By selecting the “next” button 1902, an embodiment 2000, as shown in FIG. 20, of an exemplary screen shot of a display produced by the present service order tracking system 100 that depicts exceptions 2002 that may be selected for the service orders 206. By selecting the “next” button 2004, an embodiment 2100, as shown in FIG. 21, of an exemplary screen shot of a display produced by the present service order tracking system 100 that depicts a rule name field 2102 for identifying the rule created as described above. In this embodiment, the name field 2102 is populated with the identifier “040804,” which corresponds to the conversion date of this embodiment. After the name field 2102 has been populated, the turn rule on checkbox 2104 is selected to initiate the 040804 rule. By selecting the “finish” button 2106, an embodiment 2200 as shown in FIG. 22 is preferably displayed to the user.

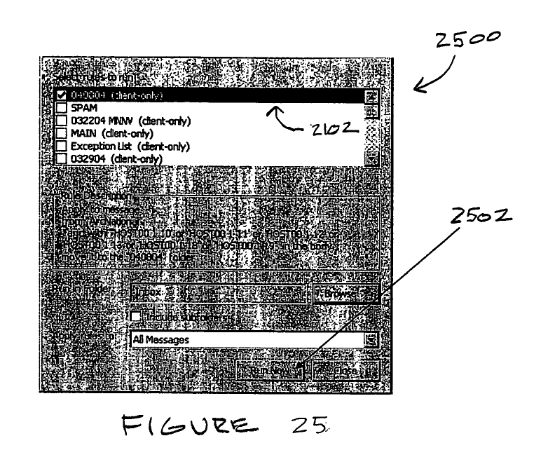

FIG. 22 illustrates an embodiment 2200 of an exemplary screen shot of a display produced by the present service order tracking system 100 that depicts a selection of rules 2206 that may have been previously selected by the user to operate on the service orders 206 for prioritizing them in the order that the user desires for them to displayed. As can be seen from the selection of rules 2206, the 040804 rule is placed at the top of the list for first display. By selecting the “run now” button 2204, an embodiment 2300 as shown in FIG. 23 is preferably displayed to the user. Referring to FIGS. 23 and 24, the 040804 rule 2102 is selected and then an email folder, “Inbox” 2402, on the email client application 108 and/or 110 is selected via the “browse” button 2302 as shown in embodiment 2400. FIG. 25 illustrates an embodiment 2500 of an exemplary screen shot of a display produced by the present service order tracking system 100 that depicts an initiate or “run now” button 2502, which when selected operates the rule 2102.

Additional rules are created to correspond to any other conversion dates, such as described above. As the service orders 206 come into the main “Inbox” of the present service order tracking system 100, they are moved into their respective subfolder 304 for ease of viewing and scheduling by either the remote office or the central office.

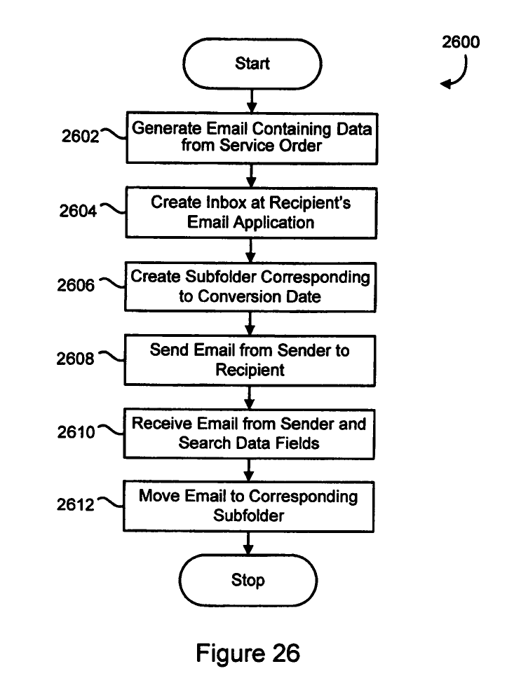

In addition to the aforementioned aspects and embodiments of the service order tracking system 100, the present invention further includes methods for tracking service orders. As described above, preferably the sender and recipient of the emails containing service order information or data each have an email application that are in communication with a communications network. FIG. 26 illustrates a flow diagram of an embodiment 2600 of one such method. In step 2602, a sender or originator of a service order generates an email that preferably contains a subject field and a body. Preferably, the date of the service activity for the service order is entered into the subject field of the email, as described above. In addition, the body of the email is populated with information or data related to that particular service activity, such as the conversion of a line from a circuit system to a packet system. This information or data is typically in the form of alphanumerical characters.

In step 2604, the recipient creates an inbox at their email application for receiving the emails sent by the sender. In step 2606, the recipient creates at least one subfolder that is identified by a conversion date associated with a particular set of dates associated with a particular service activity, such as a conversion date for converting such lines over. The subfolders are preferably in communication with the inbox. In step 2608, the email is sent from the sender to the recipient over the communications network, such as the Internet, intranet, or other communications networks whether wired or wireless.

In step 2610, the email is received in the inbox of the recipient's email application. In step 2612, the recipient's email application searches the subject fields and body of the email after receiving the email. Preferably, it also searches the email address of the sender. In step 2612, the recipient's email application then moves the email to a corresponding one of the subfolders identified with the particular service activity date as searched in the subject line.

Although there has been described what is at present considered to be the preferred embodiments of the service order tracking system 100 and methods for tracking service orders, it will be understood that the present service order tracking system 100 can be embodied in other specific forms without departing from the spirit or essential characteristics thereof. For example, other applications, users, service order types, and computers could be used, other than those described herein could be used without departing from the spirit or essential characteristics of the present service order tracking system. The present embodiments are, therefore, to be considered in all aspects as illustrative and not restrictive. The scope of the invention is indicated by the appended claims rather than the foregoing description.

What is claimed is:

1. A method for tracking service orders of service activities each having a service activity date from a sender to a recipient with an email application operating via a communications network, the method comprising:
generating at said sender an email having a first portion including a first data from said service order and a second portion including a second data from said service order;
creating an inbox at said recipient for the receipt of said email;
creating at least one subfolder at said recipient identified by a conversion date associated with a particular set of first data, said at least one subfolder in communication with said inbox;
sending said email to said recipient over said communications network;
receiving said email at said inbox;
searching, responsive to said receipt of said email in said inbox, said first data and said second data of said email; and
moving said email to a corresponding one of said at least one subfolders identified by said first data of said service order.

2. The method of claim 1 wherein said first data of said service order are alphanumerical characters corresponding to said service activity date.

3. The method of claim 1 wherein said second data of said service order are alphanumerical characters corresponding to a descriptor of said service activity.

4. The method of claim 1 wherein said receiving said email at said inbox further comprises:
receiving said email from a selected sender.

5. The method of claim 1 wherein first portion comprises a subject line of said email.

6. The method of claim 1 wherein said second portion comprises a body of said email.

7. The method of claim 1 wherein said particular set of first data comprises:
a select set of service activity dates associated with said conversion date.

8. A system for tracking service orders of service activities each having a service activity date from a sender to a recipient with an email application operating via a communications network, the system comprising:
means for generating at said sender an email having a first portion including a first data from said service order and a second portion including a second data from said service order;
means for creating an inbox at said recipient for the receipt of said email;
means for creating at least one subfolder at said recipient identified by a conversion date associated with a particular set of first data, said at least one subfolder in communication with said inbox;
means for sending said email to said recipient over said communications network;
means for receiving said email at said inbox;
means for searching, responsive to said receipt of said email in said inbox, said first data and said second data of said email; and
means for moving said email to a corresponding one of said at least one subfolders identified by said first data of said service order.

9. The system of claim 8 wherein said first data of said service order are alphanumerical characters corresponding to said service activity date.

10. The system of claim 8 wherein said second data of said service order are alphanumerical characters corresponding to a descriptor of said service activity.

11. The system of claim 8 wherein said means for receiving said email at said inbox further comprises:
means for receiving said email from a selected sender.

12. The system of claim 8 wherein first portion comprises a subject line of said email.

13. The system of claim 8 wherein said second portion comprises a body of said email.

14. The system of claim 8 wherein said particular set of first data comprises:
a select set of service activity dates associated with said conversion date.

15. A system for tracking service orders of service activities each having a service activity date from a service order sender to a service order receiver with an email application operating via a communications network, the system comprising:
a first computer located at said service order sender for operating an email application to generate an email having a first portion including a first data from said service order and a second portion including a second data from said service order;
a second computer located at said service order receiver to create an inbox for the receipt of said email;
at least one subfolder on said second computer identified by a conversion date associated with a particular set of first data, said at least one subfolder in communication with said inbox;
means for sending said email to said recipient over said communications network;
means for receiving said email at said inbox;
alphanumerical search means, responsive to said receipt of said email in said inbox, for searching said first data and said second data of said email; and
means for moving said email to a corresponding one of said at least one subfolders identified by said first data of said service order.

16. The system of claim 15 wherein said first data of said service order are alphanumerical characters corresponding to said service activity date.

17. The system of claim 15 wherein said second data of said service order are alphanumerical characters corresponding to a descriptor of said service activity.

18. The system of claim 15 wherein said means for receiving said email at said inbox further comprises:
means for receiving said email from a selected sender.

19. The system of claim 15 wherein first portion comprises a subject line of said email.

20. The system of claim 15 wherein said second portion comprises a body of said email.

21. The system of claim 15 wherein said particular set of first data comprises:
a select set of service activity dates associated with said conversion date.
